(19) United States
(12) Patent Application Publication
(10) Pub. No.: US 2026/0085790 A1
(43) Pub. Date: Mar. 26, 2026

(54) HYDROGEN TANK WITH ANTI-SLOSHING BAFFLES, FUEL TANK ARRANGEMENT, AND AIRCRAFT

(71) Applicant: Airbus Operations GmbH, HAMBURG (DE)

(72) Inventors: Martin SIEMANN, HAMBURG (DE); Henning SCHEUFLER, HAMBURG (DE)

(21) Appl. No.: 19/333,740

(22) Filed: Sep. 19, 2025

(30) Foreign Application Priority Data
Sep. 24, 2024 (DE) 10 2024 127 499.9

(51) Int. Cl. F17C 1/00; B64D 37/08; B64D 37/30

(52) U.S. Cl. CPC F17C 1/00; B64D 37/08; B64D 37/30; F17C 2201/0114; F17C 2201/032; F17C 2221/012; F17C 2223/013; F17C 2250/0417; F17C 2250/0678; F17C 2270/0189

(57) ABSTRACT

A fuel tank for an aircraft, and an aircraft with such fuel tank. The fuel tank is configured to contain liquid hydrogen, and it has at least one adjustable anti-sloshing baffle. The fuel tank may have an adjustment mechanism adapted to adjust the at least one anti-sloshing baffle. Also a fuel tank arrangement with such a fuel tank and a control unit for control of the at least one adjustable anti-sloshing baffle.

### CROSS-REFERENCES TO RELATED APPLICATIONS

This application claims the benefit of German Patent Application Number 10 2024 127 499.9 filed on Sep. 24, 2024, the entire disclosure of which is incorporated herein by way of reference.

### FIELD OF THE INVENTION

The present invention concerns a fuel tank of or for an aircraft, which fuel tank is configured to contain liquid hydrogen. The invention further concerns a fuel tank arrangement and an aircraft respectively comprising such a fuel tank.

### BACKGROUND OF THE INVENTION

Aircraft typically comprise one or more fuel tanks containing a fuel to be supplied to the aircraft's one or more propulsion engines and possibly, if installed, to an auxiliary power unit such as, e.g., a turboshaft engine and/or a fuel cell etc. Different positions are known for the tanks, depending on a respective type and design of the aircraft.

Conventionally, the respective fuel may be an aviation gasoline or a jet fuel, for instance. In order to achieve a considerable emission reduction, alternative propulsion systems for aircraft have been researched for. In this respect, hydrogen-electric aircraft engines, any propulsion engine which includes piston engines, turbine engines of any architecture, and fuel cell powered electrical propulsion motors have emerged as a promising possibility, for instance. In particular, turbo fans and fuel /lls/ electric engines respectively driven with hydrogen have been developed as aircraft engines. In either case, considerable space (volume) is needed, in the aircraft, for the hydrogen storage even in the liquid state thereof. Therein, to minimize lost energy due to boil-off, a tank with a large capacity and an advantageous surface-to-volume ratio is advisable.

However, when liquid content in a large pressure vessel enclosing a single tank space becomes only partially filled, there is a risk of sloshing (i.e., of a movement of the liquid inside the vessel), as may occur when the vessel is moved hastily. The sloshing effects that a center of gravity of the combined tank and liquid may move, thus provoking a dynamic loading. In case of an aircraft's tank, where the hasty movement may occur during maneuvering of the aircraft, large such moves are detrimental to a steering and control of the movement.

If the content of the vessel is liquid hydrogen, the sloshing may further result in a mixing between the cooler liquid hydrogen from the bottom of the tank with the gaseous hydrogen, which may implicate recondensation and thermodynamic challenges.

In order to mitigate sloshing effects, anti-sloshing walls may be installed in tanks, as disclosed, e.g., in EP 23170281.2.

### SUMMARY OF THE INVENTION

It is an object of the present invention to provide for a fuel storage in an aircraft that preferably addresses one or more of the foregoing.

The object may be achieved by a fuel tank according to one or more embodiments described herein, by a fuel tank arrangement according to one or more embodiments described herein, and by an aircraft according to one or more embodiments described herein.

A fuel tank according to the present invention is a hydrogen tank configured as a fuel tank of or for an aircraft. It is thus constructed as a pressure vessel adapted to contain liquid hydrogen as a fuel to be supplied to at least one (propulsive and/or non-propulsive) engine of the aircraft.

The fuel tank according to the present invention comprises, arranged in its tank space, at least one (actively) adjustable anti-sloshing baffle.

To simplify the language, the attribute “anti-sloshing” to the “baffle” is sometimes omitted herein, i.e., the anti-sloshing baffle(s) are also briefly referred to as “baffle”only.

By virtue of its adjustability, the at least one baffle may be advantageously actively adaptable to a respective condition (such as a fill state of the fuel tank or a circumstance of its utilization), so as to respectively optimize its anti-sloshing effect. Thereby, an active damping of a motion of liquid hydrogen the fuel tank may contain is facilitated.

In particular, the present invention advantageously facilitates lessening a dynamic loading resulting from the sloshing and acting on the tank itself (so-called “local loading”) and/or on a tank support structure of the fuel tank (so-called “global loading”). Thereby, adverse impacts on the fuel tank, on equipment, and on performance of the aircraft can be avoided, and a particularly lightweight design of the fuel tank is facilitated. Moreover, the baffle(s) reduce an amount of mixing of hydrogen of different temperatures and/or differently phased hydrogen within the tank space (such as cooler liquid hydrogen from the bottom of the tank space and a gaseous/vaporized hydrogen formed above the liquid), thereby decreasing a heat/mass transfer, reducing a pressure change within the tank space and, thus, decreasing thermodynamic challenges. In particular, the one or various baffles serve to reduce a sloshing-induced heat and mass transfer and thus provide for an increased performance of an aircraft comprising the fuel tank.

In particular, the at least one adjustable baffle is arranged in the tank space of the fuel tank so as to have one or various degrees of freedom allowing for adjusting the at least one anti-sloshing baffle.

For instance, an adjustment possible for the at least one anti-sloshing baffle may include a tilting thereof (relative to a tank wall of the fuel tank).

Additionally or alternatively, the at least one baffle may be adjustable by changing its position in the tank space of the fuel tank (relative to a/the tank wall of the fuel tank). Thereby, an advantageous adaptation to a respective fill level can be realized. In particular, an effective anti-sloshing may be achieved even with a low number of baffles (and consequently a reduced weight of the fuel tank).

Additionally or alternatively, an adjustment possible for the at least one anti-sloshing baffle may include modifying its diameter; for instance, the at least one baffle in such case may include at least two panels having a smaller diameter than the tank space and being movable relative to each other so as to selectively enlarge or diminish a size of the baffle (by increasingly supplementing or overlapping each other, respectively). Such movement may include a rotation and/or a translation of the panels relative to each other. Such modifiable diameter may be in particular advantageous in embodiments in which a position of the at least one baffle is variable between a narrower region and a wider region of the tank space, as in such case, the diameter of the at least one baffle may be adapted accordingly.

The at least one anti-sloshing baffle may additionally or alternatively be adjustable by rotating the at least one anti-sloshing baffle within the tank space of the fuel tank; this may be in particular advantageous in cases where the respective baffle is rotationally asymmetric.

As a further (alternative or additional) possibility, the at least one baffle may form an at least partially closable passageway, a size and/or shape of which may be variable for adjustment of the baffle; for instance, such baffle may include two or more slices each forming at least one opening, wherein the slices are movable (e.g., rotatable and/or translatable) relative to each other so as to vary an extent to which the respective openings are in line with each other.

Preferably, the fuel tank comprises an adjustment mechanism adapted to (actively) adjust the at least one anti-sloshing baffle.

In particular, such adjustment mechanism may comprise a guiding structure the at least one baffle may be mounted to. Such guiding structure may cross the tank space and/or comprise at least a portion running along a tank wall of the fuel tank. It may include a rod and/or a hollow cylinder, and/or it may be connected to a gear the adjustment mechanism may further comprise. With regard to the fuel tank's designated orientation of installation detailed below, such rod and/or hollow cylinder may preferably run vertically. In embodiments where the fuel tank has a longish shape as mentioned below, the rod and/or hollow cylinder may at least partially or entirely run along a/the longitudinal axis of the fuel tank.

If the fuel tank includes various baffles, at least two of these baffles may be actively adjustable, by means of the adjustment mechanism, synchronously with each other, asynchronously with each other, or selectively synchronously and asynchronously with each other, in particular independently of each other. Such embodiments facilitate achieving a particularly comprehensive suppression of sloshing movements within the tank space. For example, to optimize an effectiveness of the anti-sloshing, the at least two baffles may be (preferably selectively) tiltable in a common direction or in different, in particular opposite directions.

The fuel tank according to the present invention may preferably be configured to be installed in the aircraft in a designated orientation of installation. Said designated orientation is to be perceived as relating to the ground. Indeed, as is to be understood, the aircraft referred to in this definition is assumed to be oriented for horizontal flight. Accordingly, when the fuel tank is installed as intended within the aircraft, it takes its designated orientation (relative to the ground) when the aircraft is oriented for horizontal flight.

As understood in the art, said designated orientation of installation may be constituted, for example, by respective positions of one or various pipes the fuel tank may comprise (e.g., in its tank space), the pipes configured for controlling and collecting boiled off gaseous hydrogen, and/or for collecting liquid hydrogen (e.g., to unload or to supply it to an engine of the aircraft). Additionally or alternatively, said designated orientation may be defined by at least one support element possibly comprised by the fuel tank and configured to support the fuel tank in said designated orientation in a fuselage of the aircraft. Such support element may in particular be configured as a base or stand supporting the fuel tank against a fuselage reinforcement structure (e.g., frames) of the aircraft, for example.

With regard to the designated orientation of installation of the fuel tank (i.e., when the fuel tank is oriented accordingly), the at least one adjustable anti-sloshing baffle may preferably extend horizontally or be at least adjustable to extend horizontally.

As is to be understood, an anti-sloshing baffle is considered to extend horizontally if it faces downwards with one of its two opposite baffle surfaces respectively spanning a main two-dimensional extension of the respective anti-sloshing baffle.

Such horizontal orientation improves the anti-sloshing baffle's ability to counteract downward and upward movements of liquid hydrogen the fuel tank may contain. In particular, waves occurring in a surface of the liquid hydrogen may strike against at least one of the oriented baffles which thereby may serve to dampen the hydrogen's agitation in a particularly efficient way.

In particular, the one or more adjustable baffles comprised by a fuel tank according to the present invention may preferably define two or more stacked sections within the fuel tank, wherein a lower section is connected to an upper section by one or various passageways through and/or aside the baffles. Accordingly, such lower section may be completely filled even at a reduced filling state of the fuel tank, such that sloshing is in particular suppressed efficiently within the lower section.

According to advantageous embodiments, the fuel tank may comprise various anti-sloshing baffles, at least a first one of which may be mounted, with regard to said orientation designated for installation of the fuel tank, above a second one of the baffles. Accordingly, three or more of said stacked sections may be created, whereby said effects may be achieved even during continued consumption of hydrogen from the fuel tank.

The fuel tank according to the present invention may advantageously be double-walled. In particular, it may comprise an outer hull, an inner tank delimiting the tank space of the fuel tank, and an insulation layer (such as a quasi-vacuum) between the outer hull and the inner tank.

According to advantageous embodiments, the fuel tank may have a longish shape. For example, it may comprise a tubular tank wall whose open ends are closed by respective caps. In particular, such tubular tank wall may comprise a cylindric and/or a conical section.

In these cases, with regard to said designated orientation of installation of the fuel tank, a longitudinal axis (such as a center axis of said cylindrical and/or conical portion, if applicable) of the fuel tank may extend vertically. Accordingly, the fuel tank may be designated for installation, in the aircraft, in an upright manner (as disclosed in EP23217785.7). Thereby, said sections can be realized to have a relatively small diameter, such that sloshing movements within the tank are advantageously delimited.

Alternatively, again with regard to said designated orientation of installation of a longish fuel tank, its longitudinal axis may extend horizontally, which may facilitate a particularly advantageous utilization of the aircraft's volume.

According to advantageous embodiments, at least one of the one or various baffles (i.e., the one baffle or at least one of the one or various baffles) of a fuel tank according to the present invention may be arranged in a region which is narrowed as compared to a widest region of the tank space. Accordingly, a respective anti-sloshing effect can be achieved even in such narrow region. For instance, such baffle may be arranged in a dome of the tank or in non-spherical or non-cylindrical part thereof.

A fuel tank arrangement according to the present invention comprises a fuel tank including an adjustment mechanism as detailed above, and a control unit (which may comprise a computer) configured to control the adjustment mechanism so as to automatically adjust the at least one anti-sloshing baffle based on one or various predefined situation-dependent conditions. Accordingly, the at least one baffle in such embodiment can be systematically adapted to respective situations in accordance with a set of one or various pre-defined rules. Thereby, a particularly smart adjustment of the baffles may be achieved.

The situation-dependent condition may include, for example, a respectively current fill level of the fuel tank and/or a respectively detected current gust which the fuel tank (when installed in the aircraft) is subject to (i.e., which acts on the fuel tank).

In particular, if the fuel tank comprises at least two baffles, the control unit may be configured to effect an individual tilting thereof. For instance, in embodiments in which a first one of the baffles is arranged above another one of the baffles, the control unit may be configured to effect a tilting of only the first baffle when the fuel tank is full, and/or tilting only the other baffle when the fuel tank is merely partially filled with liquid hydrogen.

The fuel tank arrangement may further comprise one or various sensors configured to repeatedly detect, inside or outside the fuel tank, at least one (respective) current parameter (which thus is prevailing at the respective point of time) the situation dependent conditions may be based on, and to transmit the respectively detected parameters to the control unit.

An aircraft according to the present invention comprises at least one fuel tank according to an embodiment of the present invention, preferably even a fuel tank arrangement according to an embodiment of the present invention.

The fuel tank may preferably be installed, within a fuselage of the aircraft, so as to take a designated orientation of installation (as mentioned above) when the aircraft is oriented for horizontal flight. Preferably, the at least one fuel tank may be installed in an unpressurised aft portion of the fuselage. According to advantageous embodiments, the aircraft comprises at least two fuel tanks each in accordance with a (possibly respective) embodiment of the present invention. Therein, the at least two fuel tanks may be arranged one behind the other in said unpressurised aft portion, such that the aircraft implements a caudal tandem configuration. Additionally or alternatively, the aircraft may comprise at least two fuel tanks in accordance with a (possibly respective) embodiment of the present invention which are arranged side by side in said unpressurised aft portion.

The at least one fuel tank preferably is connected, by a fuel supply system, with at least one propulsive engine and/or at least one non-propulsive engine of the aircraft.

### BRIEF DESCRIPTION OF THE DRAWINGS

In what follows, preferred embodiments of the present invention are explained with respect to the accompanying drawings. As is to be understood, the various elements and components are depicted as examples only, may be facultative and/or combined in a manner different than that depicted. Reference signs for related elements are to some extent used comprehensively and not necessarily defined again for each figure, and the same holds for evident analogies between the figures.

Shown are schematically in

FIG. 1a is a fuel tank arrangement according to a first exemplary embodiment of the present invention in a first state;

FIG. 1b is the fuel tank arrangement of FIG. 1a in a second state;

FIG. 1c is the fuel tank arrangement of FIGS. 1a and 1b in a third state;

FIG. 2a is a possible anti-sloshing baffle of a fuel tank according to an exemplary embodiment of the present invention;

FIG. 2b is the baffle of FIG. 2a in a modified state;

FIG. 3a is a fuel tank according to a further exemplary embodiment according to the present invention in a longitudinal view;

FIG. 3b is the fuel tank of FIG. 3a in a transverse view; and

FIG. 4 is an aircraft according to an exemplary embodiment of the present invention.

### DETAILED DESCRIPTION OF THE PREFERRED EMBODIMENTS

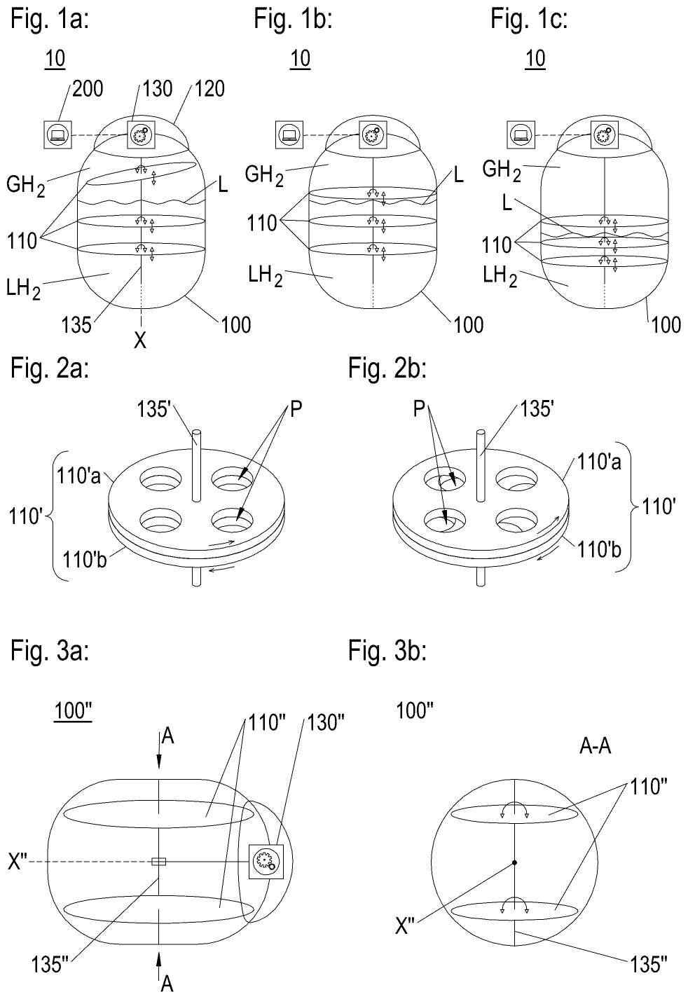

In FIG. 1a-1c, a fuel tank arrangement 10 according to an exemplary embodiment of the present invention is depicted in respective states/situations.

The fuel tank arrangement 10 comprises a fuel tank 100 according to an exemplary embodiment of the present invention, which fuel tank has a longish shape and is shown in a designated orientation of installation, in which a longitudinal axis X of the fuel tank 100 runs vertically. The fuel tank 100 may in particular be double-walled with an outer hull, an inner tank delimiting a tank space of the fuel tank, and a (e.g., quasi-vacuum) insulation layer between the outer hull and the inner tank (not shown).

In the illustrated example, the fuel tank 100 comprises three anti-sloshing baffles 110, which in this case each are shaped as a respective disc, and an adjustment mechanism 130 with a gear arranged in a capsule 120 of the fuel tank 100 at a top thereof. The adjustment mechanism 130 further comprises a guiding structure 135 running along the longitudinal axis X and thus in particular crossing the inner space of the fuel tank 100. For example, the guiding structure 135 may include a rod and/or a hollow cylinder (not visible in the figures).

Within the tank space of the fuel tank 100, the baffles 110 are mounted one above the other and each at their respective center to the guiding structure 135. Therein, the baffles 110 each have respective degrees of freedom, as indicated in FIGS. 1a-1c by respective double arrows. Accordingly, in the present example, the baffles 110 are tiltable relative to the longitudinal axis X (preferably in each direction around said axis X) and thereby to a tank wall of the fuel tank 100. Moreover, their respective position in the tank space is changeable along the guiding structure 135.

Therein, the adjustment mechanism 130 is configured to adjust the baffles 110 corresponding to their respective degrees of freedom. In particular, in the fuel tank's orientation designated for installation, as shown in FIG. 1a-1c, the baffles can be adjusted so as to extend horizontally. Indeed, FIGS. 1b and 1c show each baffle aligned accordingly, whereas in the situation shown in FIG. 1a, only the two lowest baffles 110 extend horizontally, while the upmost one is currently tilted. In particular, at least the upmost one of the baffles 110 thus can be adjusted asynchronously to the lower ones of the baffles 110.

As apparent from FIG. 1a-1c, the baffles 110 define four stacked sections within the fuel tank 100, wherein the sections are variable due to the adjustability of the baffles 110 and connected to each other by passageways through and/or aside the baffles (not visible in FIGS. 1b, 1c and only visible for the upmost baffle 110 in FIG. 1a).

In the situations shown in FIG. 1a-1c, the fuel tank 100 contains liquid hydrogen LH₂ and gaseous hydrogen GH₂. Therein, FIGS. 1a and 1b show the fuel tank with a higher fill level (of liquid hydrogen) than FIG. 1c. As compared to the situation shown in FIG. 1a, in the state depicted in FIG. 1b, the upmost one of the baffles has been moved downwards, along the center axis X, to the vicinity of a surface L of the liquid hydrogen LH₂ up to touching said surface L.

Thereby, the two lowest sections of the tank space are completely filled with liquid hydrogen LH₂, the second section from above is at least almost filled with liquid hydrogen LH₂, and the upmost section is at least almost completely filled with gaseous hydrogen GH₂. As a consequence, an improved anti-sloshing effect is achieved.

In the situation shown in FIG. 1c, the baffles 110 have been further moved downwards to adapt to the further reduced fill level of the fuel tank 100. Thereby, the lowest three sections in the fuel tank are diminished to achieve an improved anti-sloshing at this reduced fill level state.

To accordingly facilitate such smart adaptation and control the adjustment mechanism 130 so as to automatically adjust the baffles 110 based on the fill level, the fuel tank arrangement 10 shown in FIG. 1a-1b comprises a control unit 200. The control unit 200, which includes a computer, may further be configured to control the adjustment mechanism 130 based on at least one other predefined situation-dependent condition such as a respective gust acting on the fuel tank (in particular, when installed in the aircraft).

According to advantageous embodiments, the fuel tank arrangement comprises at least one sensor (not shown) configured to repeatedly detect at least one (respective) current parameter (e.g., a current tank fill level and/or a gust) the situation dependent conditions are based on, and to transmit the respectively detected (and current) parameters to the control unit 200.

FIGS. 2a and 2b show, in respective situations, a possible configuration at least one baffle 110′ a fuel tank according to the present invention may comprise. The baffle 110′ comprises two slices 110′a, 110′b which are rotatable relative to each other about a guiding structure 135′ to which the baffle 110′ is mounted.

In the exemplary embodiment depicted, both slices 110′a, 110′b have four openings which in the exemplary embodiment shown each are disk-shaped. According to alternative embodiments, at least one of such openings may have a different shape such as a polygonal, in particular a triangular shape.

In the situation shown in FIG. 2a, the openings of slice 110′a each are in line with a respective opening of slice 110′b. Thereby, passageways P through the baffle 110 are formed.

As compared to this situation, FIG. 2b shows a state in which the slices 110′a, 110′b have been rotated relative to each other, whereby an extent to which the respective openings are in line with each other has been diminished. As a consequence, a respective size of the passageways P is reduced, such that they are partially closed and a shape of the passageways P is modified.

FIGS. 3a, 3b illustrate a fuel tank 100″ according to a further exemplary embodiment of the present invention. Therein, the fuel tank 100″ is shown in its designated orientation of installation which in this case is such that a longitudinal axis X″ of the longish fuel tank 100″ runs horizontally. In FIG. 3a, said axis X″ runs along the image plane, whereas FIG. 3b provides a transverse view of the fuel tank 100″, in which the axis X″ is orthogonal to the image view. Again, the fuel tank 100″ may advantageously be double-walled with an outer hull, an inner tank delimiting the tank space of the fuel tank, and a (e.g., quasi-vacuum) insulation layer between the outer hull and the inner tank (not shown).

The fuel tank 100″ shown in FIGS. 3a, 3b comprises two adjustable baffles 110″ which each are mounted, with a respective degree of freedom, to a guiding structure 135″ of an adjustment mechanism 130″.

Therein, the respective diameter of each baffle 110″ is smaller than an inner tank diameter, whereby an arrangement of the baffles 110″ respectively above or below a widest region of the fuel tank 100″ (and thus in a region which is narrowed as compared to said widest region) is facilitated. Accordingly, a beneficial anti-sloshing effect can be achieved also outside a center of the fuel tank 100″.

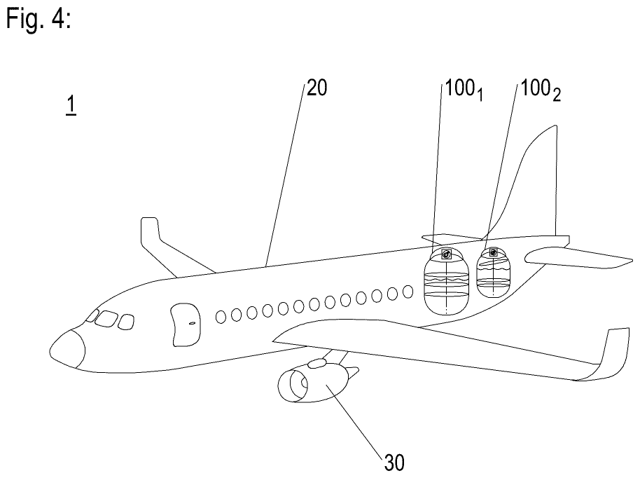

FIG. 4 shows an aircraft 1 according to an exemplary embodiment of the present invention, the aircraft 1 comprising two fuel tanks 100₁, 100₂ which in this case are configured as is the fuel tank 100 shown in FIG. 1a-1c and described above. The fuel tanks 100₁, 100₂ are arranged, in a caudal tandem configuration and each in an upright orientation, in a fuselage 20 of the aircraft 1.

Preferably, a supply system (not shown) of the aircraft is configured to supply at least one engine 30 of the aircraft with liquid hydrogen from the fuel tanks 100₁, 100₂.

The respective baffles within the fuel tanks 100₁, 100₂ and their associated adjustment mechanism facilitate an active damping of a motion of the liquid hydrogen they respectively contain. Thereby, the baffles serve to reduce a sloshing-induced heat and mass transfer and thus provide for an increased performance of the aircraft 1.

Disclosed are a fuel tank 100, 100″, 100₁, 100₂ of or for an aircraft 1, and an aircraft 1 comprising such fuel tank. The fuel tank is configured to contain liquid hydrogen LH₂, and it comprises at least one adjustable anti-sloshing baffle 110, 110′, 110″. The fuel tank may preferably comprise an adjustment mechanism 130, 130″ adapted to adjust the at least one anti-sloshing baffle 110, 110′, 110″.

Further disclosed is a fuel tank arrangement comprising such fuel tank 100, 100″, 100₁, 100₂ with an adjustment mechanism 130, 130″, and a control unit 200 for control of the adjustment mechanism 130, 130″.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE SIGNS

1 aircraft
10 fuel tank arrangement
20 fuselage
30 engine
100, 100″, 100₁, 100₂ fuel tank
110, 110′, 110″ anti-sloshing baffle
110′a, 110′b
120 capsule
130, 130″ adjustment mechanism
135, 135′, 135″ guiding structure
200 control unit
GH₂ gaseous hydrogen
L surface of liquid hydrogen
LH₂ liquid hydrogen
P passageway
X, X″ longitudinal axis

Claimed is:

1. A fuel tank of or for an aircraft, the fuel tank configured to contain liquid hydrogen (LH₂) and comprising:
a tank space having at least one anti-sloshing baffle, the at least one at least one anti-sloshing baffle configured to be adjustable.

2. The fuel tank according to claim 1, wherein the at least one anti-sloshing baffle is configured to be adjustable by:
tilting the at least one anti-sloshing baffle relative to a tank wall of the fuel tank;
changing a position of the at least one anti-sloshing baffle in the tank space of the fuel tank;
modifying a diameter of the at least one anti-sloshing baffle;
varying a size of at least one at least partially closable passageway formed in the at least one anti-sloshing baffle;
varying a shape of at least one at least partially closable passageway formed in the at least one anti-sloshing baffle;
rotating the at least one anti-sloshing baffle within the fuel tank; or
any combination of the foregoing.

3. The fuel tank according to claim 1, wherein the at least one anti-sloshing baffle is mounted to a guiding structure which crosses the tank space, or which at least partially runs along a tank wall of the fuel tank, or both.

4. The fuel tank according to claim 1, further comprising:
an adjustment mechanism configured to adjust the at least one anti-sloshing baffle within the tank space.

5. The fuel tank according to claim 4, wherein the at least one anti-sloshing baffle comprises at least two anti-sloshing baffles configured to be adjusted independently from each other by the adjustment mechanism.

6. The fuel tank according to claim 1, wherein the fuel tank has a shape, and a designated orientation of installation in the aircraft such that a longitudinal axis of the fuel tank runs vertically or a longitudinal axis of the fuel tank runs horizontally.

7. A fuel tank arrangement comprising:
the fuel tank according to claim 1; and
a control unit configured to automatically adjust the at least one anti-sloshing baffle based on one or more predefined situation-dependent conditions.

8. The fuel tank arrangement according to claim 7, wherein the one or more predefined situation-dependent conditions comprise a respectively current fill level of the fuel tank, or a respectively current gust acting on the fuel tank, or both.

9. An aircraft comprising:
the fuel tank according to claim 1.
